(19) United States
(12) Patent Application Publication
(10) Pub. No.: US 2026/0239097 A1
(43) Pub. Date: Aug. 13, 2026

(54) SYSTEMS AND METHODS FOR TRAFFIC CLASSIFICATION AND HANDLING

(71) Applicant: ZTE CORPORATION, Shenzhen, Guangdong (CN)

(72) Inventors: Zhijun LI, Shenzhen (CN); Jinguo ZHU, Shenzhen (CN)

(21) Appl. No.: 19/469,427

(22) PCT Filed: Mar. 31, 2023
(86) PCT No.: PCT/CN2023/085362

§ 371 Date: Sep. 26, 2025

(51) Int. Cl. H04W 28/02; H04L 47/19

(52) U.S. Cl. CPC H04W 28/0268; H04L 47/19

(57) ABSTRACT

The present arrangement relates to systems, methods, and non-transitory computer-readable media for traffic classification and handling. The systems, methods, and non-transitory computer-readable media may include configuring, by a wireless communication device within a Quick User Datagram Protocol (UDP) Internet Connection (QUIC) network, traffic classification information in a QUIC packet header of a QUIC packet; and sending, by the wireless communication device to an endpoint of the QUIC network, the QUIC packet with the traffic classification information in the QUIC packet header.

### CROSS-REFERENCES TO RELATED APPLICATIONS

This is a National Stage Application, filed under 35 U.S.C. 371, of International Patent Application No. PCT/CN2023/085362, filed on Mar. 31, 2023, the disclosure of which is incorporated herein by reference in its entirety.

### TECHNICAL FIELD

The disclosure relates generally to wireless communications and, more particularly, to quick user datagram protocol (UDP) internet connection (QUIC).

### BACKGROUND

In 5^{th} Generation Mobile Network System (5GC), QUIC is a key technology in new radio (NR) systems. QUIC features may support setup for secure international connections between two end points.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, traffic classification information in a Quick User Datagram Protocol (UDP) Internet Connection (QUIC) packet header of a QUIC packet is configured. A wireless communication device within a QUIC network can configure the traffic classification information. The wireless communication device can send, to an endpoint of the QUIC network, the QUIC packet with the traffic classification information in the QUIC packet header.

In some arrangements, a QUIC packet containing traffic classification information in a QUIC packet header is received. A first network entity of a core network can receive the QUIC packet. The first network entity can report, to a second network entity of the core network, QUIC traffic information. The first network entity can receive, from the second network entity, Packet Forwarding Control Protocol (PFCP) rules. The first network entity can apply the PFCP rules to the QUIC traffic information.

In some arrangements, QUIC traffic information may be received. A second network entity of a core network can receive the QUIC traffic information from a first network entity of the core network. The second network entity can determine PFCP rules for a QUIC traffic. The second network entity can send, to the first network entity, PFCP rules applied to the QUIC traffic.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 is a diagram illustrating an example wireless communication architecture, according to various arrangements.

FIGS. 4A and 4B are diagrams illustrating example packet formats for traffic classification and handling, according to various arrangements.

FIG. 5 is a diagram illustrating an example wireless communication for traffic classification and handling, according to various arrangements.

FIG. 6 is a flowchart diagram illustrating an example method for traffic classification and handling, according to various arrangements.

FIG. 7 is a flowchart diagram illustrating an example method for traffic classification and handling, according to various arrangements.

FIG. 8 is a flowchart diagram illustrating an example method for traffic classification and handling, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless device may communicate with a network. The network may support Quick User Datagram Protocol (UDP) Internet Connection (QUIC). As part of the communication process, the wireless device may communicate various packets according to QUIC (e.g., QUIC packets). However, the QUIC packets may be limited in types of information presented, which may result in unrecognizable types of payloads of the QUIC packets and inefficient detection of QUIC traffic, among other deficiencies. The arrangement disclosed herein provides enhancements (e.g., additions, updates, changes) to QUIC headers and rules for QUIC traffic. To do so, wireless communications systems may include traffic classification information in a QUIC packet header, determining PFCP rules for QUIC traffic, and applying the PFCP rules for the QUIC traffic.

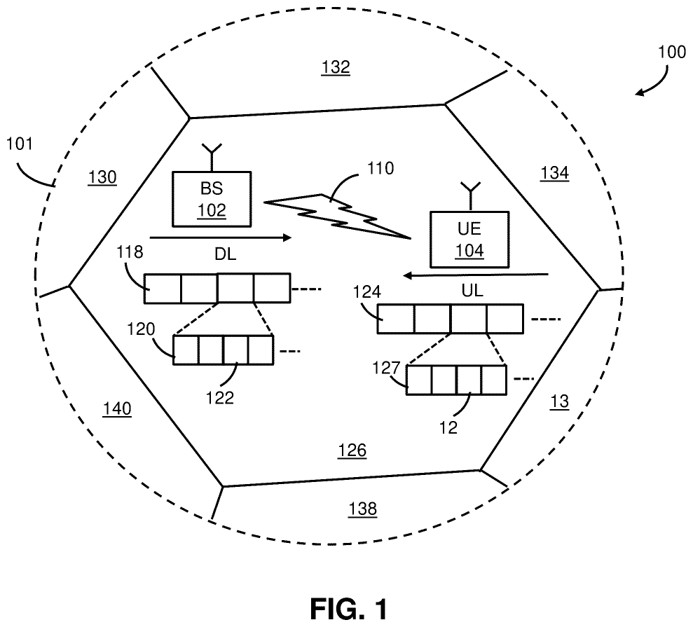

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support MIMO communication. For example, MIMO is a key technology in new radio (NR) systems. MIMO may be functional in both frequency division duplex (FDD) and time division duplex (TDD) systems, among others. MIMO technologies may utilize reporting mechanisms such as CSI to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more CQIs in the CSI report, the reference signals are aperiodic or semi-persistent, and each of a CSI window length, DD basic unit size, an offset between two CSI reference signal (CSI-RS) resources, and a length of DD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

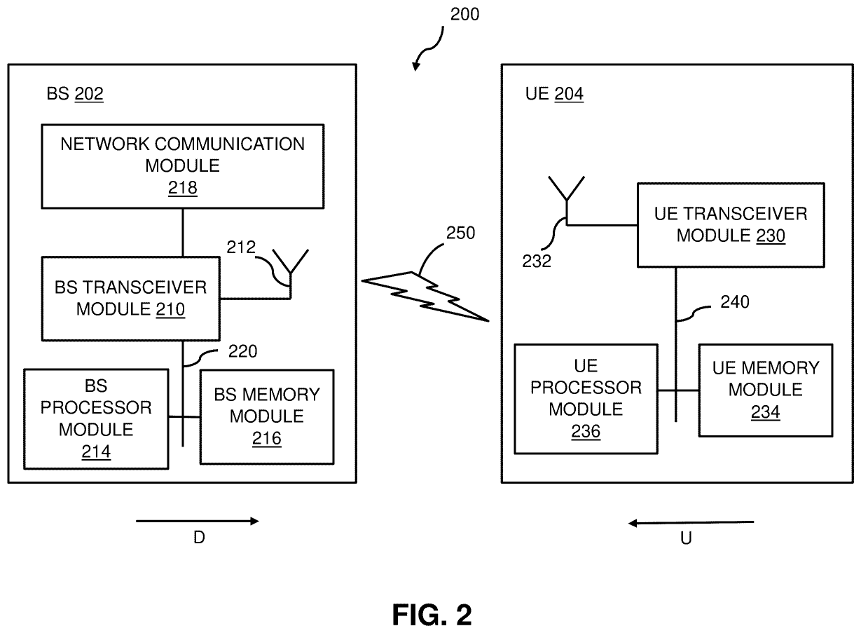

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

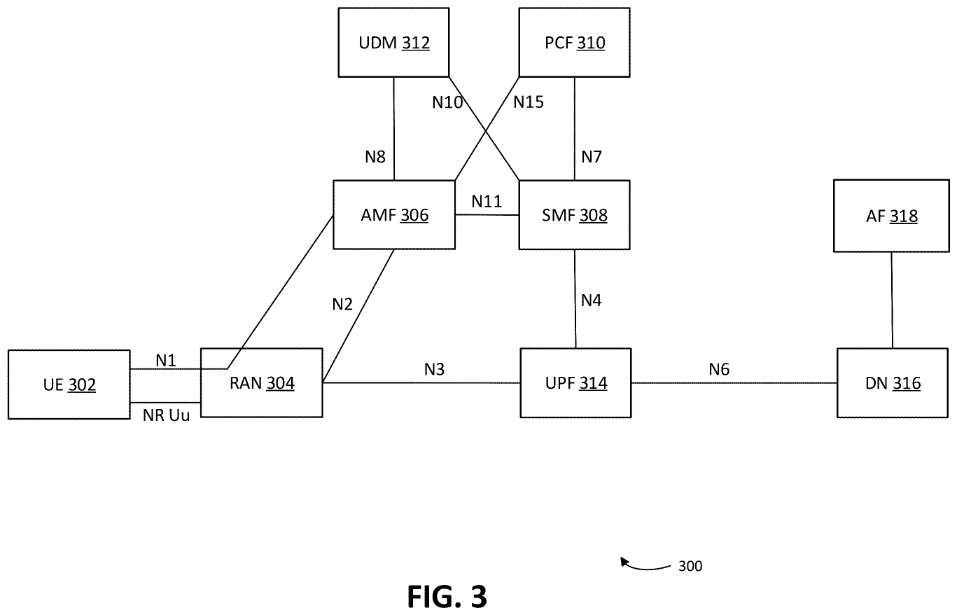

FIG. 3 is a diagram illustrating an example wireless communication architecture 300, according to various arrangements. The architecture 300 may include various entities (e.g., wireless communication nodes, network nodes, nodes). For example, the entities may include a user equipment (UE) 302, a Radio Access Network (RAN) 304, an Access and Mobility Management Function (AMF) 306, a Session Management Function (SMF) 308, a Policy Control Function (PCF) 310, a Unified Data Management (UDM) 312, a User Plane Function (UPF) 314, a Definition Network (DN) 316, and an Application Function (AF) 318. Each entity may be in wireless communication with another entity (e.g., as illustrated in FIG. 3 via interfaces N1, N2, N3, N4, N5, N6, N7, N8, N10, N11, and N15, and NR Uu, among other potential interfaces).

Some wireless communication systems may support a QUIC protocol. For example, QUIC may support setup for international connections between two end points (e.g., a next generation protocol). A QUIC connection may be a secured connection between two endpoints (e.g., between a UE and an Application Server (AS)) that may disable a transmission node in a network to inspect content transmitted in the QUIC connection. In some cases, multiple service flows between two QUIC connection endpoints (e.g., the UE and the remote AS) may be placed in different streams of one QUIC connection. Each QUIC stream may apply a respective QoS policy. A single QUIC packet can include multiple data frames to carry data blocks of different service flows. Some packet service networks (e.g., 5G networks) may support packet detection and forwarding models that may detect QUIC traffic from other transmission control protocol (TCP)/UDP. The QUIC packet header may expose limited QUIC information (e.g., QUIC transport port, QUIC connection ID). The limited information may not be sufficient for the network to determine a type of inner payload within the QUIC packet, which may result in inaccurate QoS enforcement for the detected QUIC traffics. Techniques described herein may overcome the described deficiencies by providing a method for a QUIC connection to expose traffic classification information to the network, which may result in more accurate QoS policy determination for the QUIC connection.

Referring to FIG. 3, the UE 302, may be a mobile terminal accessing a network (e.g., 5G network. The RAN 304 may be an NR base station, (e.g., a gNB). The AMF 306 may provide access management and mobility management for the UE 302 (e.g., registration to network, registration during UE mobility, etc.). The SMF 308 may provide protocol data unit (PDU) session management for the UE 302 (e.g., IP address allocation, QoS flow setup, etc.). The UPF 314 may provide IP traffic routing and forwarding management. The PCF 310 may provide QoS policy rules to control plane functions (e.g., to enforce the rules). The AF 318 may provide instruction, to the PCF 310, to influence the QoS policy rules.

In some cases, the network (e.g., a 5G network) may support data traffic transmissions controlled by the SMF 308 and the UPF 314. The SMF 308 (e.g., a control plane function (CP Function) for data traffic controlling) may handle aspects of data traffic transmission (e.g., PDU session establishment/modification/release, PFCP session establishment/modification/release, PFCP rules generation, etc.) associated with signaling. The UPF 314 (e.g., a user plane function (UP Function) for data traffic controlling) may handle aspects of data traffic transmission (e.g., traffic detection, traffic filtering, and traffic forwarding, usage reporting, etc.) associated with a user plane, based on instruction (e.g., PFCP rules) received from the SMF 308.

In some cases, the UE 302 may set up a QUIC connection with the remote server. If a QoS is selected, the network may be unable to determine a relationship (e.g., a binding relationship) between a QoS flow and the QUIC connection. Thus, the network may not generate an accurate policy for the QoS flow and the QUIC connection, and the network may not detect and guard the QUIC traffic transmission over the QoS flow.

The techniques disclosed here may provide systems and methods to allow the network to determine binding information of a QoS flow and a QUIC connection, which may result in the network generating a more accurate policy for detecting and guarding the QUIC traffic transmission over the corresponding QoS flow.

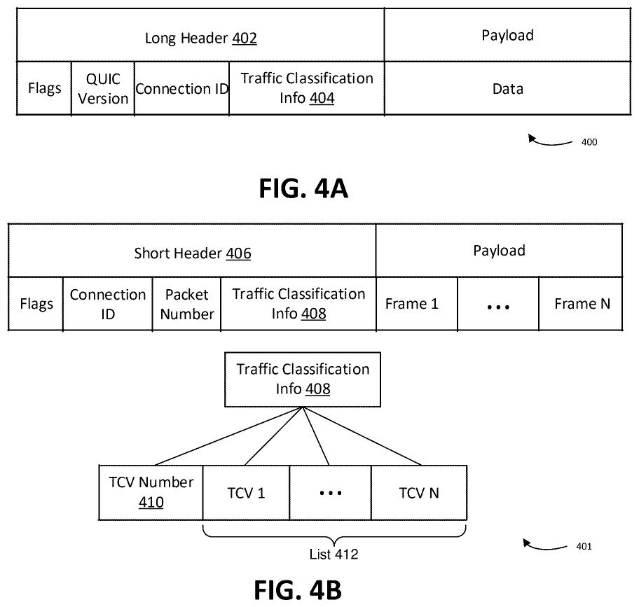

FIGS. 4A and 4B are diagrams illustrating example packet formats 400 and 401 for traffic classification and handling, according to various arrangements. The formats 400 and 401 may include various fields (e.g., header fields, data fields) of respective lengths (e.g., bit lengths, byte lengths). Each field may indicate information associated with a data packet. The format 400 may include a long header 402 and traffic classification information 404. The format 400 may include a short header 406 and traffic classification information 408. In some cases, the traffic classification information 408 may include a traffic classification value (TCV) number 410 (e.g., an indication of a quantity of TCV values), a list 412 of TCV values, or both. In some examples, the format 400 may be associated with a QUIC packet with a long header and the format 401 may be associated with a QUIC packet with a short header.

In some cases, two types of QUIC packet headers may be defined in a QUIC protocol (e.g., a long header and a short header). Long headers may be used for packets that are sent prior to an establishment of round trip time (RTT) (e.g., 1-RTT) keys. Once QUIC connection is established, and 1-RTT keys are available, a sender may switch to sending packets using the short header. The long header form may allow for special packets (e.g., a Version Negotiation packet) to be represented in a uniform fixed-length packet format. Packets that use the long header type may include a long header field, a flag field, a QUIC version field, a connection ID field, a type-specific packet payload field, and a data field, where the flag field may include a header form field, a fix bit field, a long packet type field, and a type-specific bits field. Packets that use the short header type may include a short header field, a flag field, a destination connection ID field, a packet number field, a packet payload field, and one or more frame fields (e.g., frame 1 to frame N), where the flags field includes a header form field, a fix bit field, a spin bit field, a reserved bits field, a key phase field, and a packet number length field and the frame field may include a frame type field and a payload field.

The network node may detect values of partial information elements. For example, for either type of header, if header protection is utilized, at least part of the information elements (e.g., Packet Number) in a QUIC header may be transmitted in an encrypted manner. The network node may detect the values of the partial information elements in the QUIC header (e.g., in the flags field and/or the QUIC Connection ID field for a long header). Because of the protection (e.g., security, end-to-end (E2E) encryption), contents of a packet payload in a QUIC packet may not be visible to the network node in the transmission path.

To determine and apply an accurate QoS policy, more QUIC information may be exposed in the QUIC header (e.g., when multiple service flows share a QUIC connection). For example, the network node may support (e.g., be configured, configure) a QUIC header that exposes QUIC information (e.g., QUIC traffic classification information) to intermediary nodes in the transmission path. For example, information carried in the QUIC header may be associated with the packet formats 400 or 401 to indicate QUIC traffic classification information 404 or 408. The techniques as described herein may support a QUIC packet header that includes information for QUIC traffic classification (e.g., the traffic classification information fields 404 or 408), which may result in a network node receiving QUIC traffic being able to detect an inner traffic type of the QUIC packets and calculate how to enforce a QoS policy.

In some cases, a wireless communication device (e.g., a UE or a remote AS) within a QUIC network, may configure traffic classification information in a QUIC packet header of a QUIC packet. For example, the wireless communication device may configure a QUIC packet header with a traffic classification information field 408. The traffic classification information field 408 may include information of Traffic Classification Info (TCI) without encryption. The traffic classification information may be used to expose information (e.g., belonging to a corresponding QUIC connection) of inner service flows within the QUIC traffic. The traffic classification information may include a number of TCV (e.g., indicated in the TCV number field 410) or a list of TCVs 412. The number of TCV (e.g., the TCV number 410) may indicate a total number of TCVs in the TCV list 412. Network nodes may calculate the total size of the Traffic Classification Info IE based on the TCV number 410. The TCV list 412 may include a list of TCVs (e.g., TCV 1 to N). Each TCV (e.g., TCV value) in the TCV list 412 may indicate information of a service flow among multiple inner service flows within a QUIC packet of the QUIC packet header.

In some cases, the TCV values may be set to one of a set of values. The set of values may include a QoS level (e.g., defined by the QUIC protocol, a regulating body, or directly using 3GPP defined QoS Flow Identifier (QFI) value), a priority level (e.g., defined by the QUIC protocol, a regulating body, or directly using 3GPP define Allocation and Retention Priority (ARP) value), a value indicating a type of service flow (e.g., low volume low latency service, low volume high latency service, high volume low latency service, high volume high latency service, etc.), or another value that can be mapped to a QoS requirement.

The traffic classification information carried in the QUIC packet header (e.g., at the traffic classification information field 408) may expose service flow information to intermediary nodes in a transmission path of a QUIC packet. The nodes can determine policies to control the QUIC traffic transmission (e.g., generate a QoS policy for the QUIC traffic transmission) based on the traffic classification information.

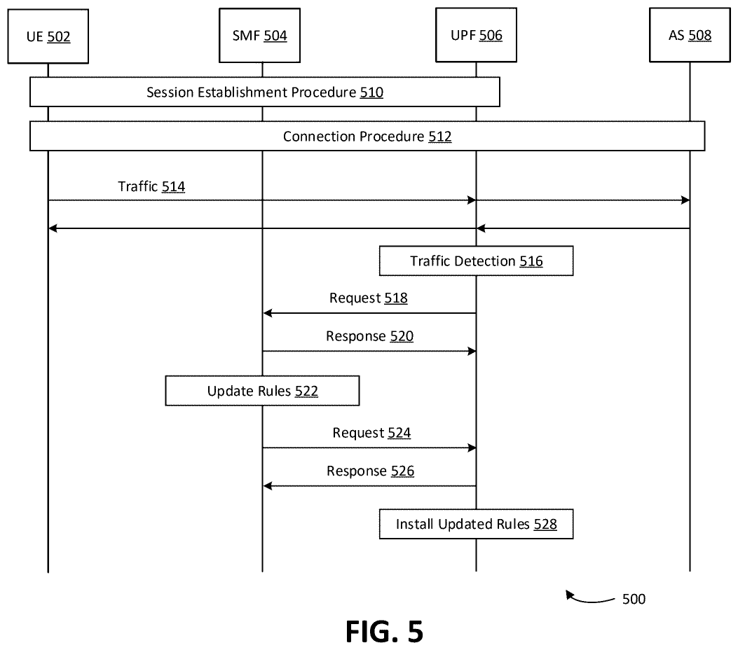

FIG. 5 is a diagram illustrating an example wireless communication 500 for traffic classification and handling, according to various arrangements. The communication 500 may include communications between a UE 502 and one or more network entities of a core network (e.g., an SMF 504, a UPF 506, and an AS 508). The communication 500 may depict examples of a procedure for detection and utilization of traffic classification information carried in a QUIC packet header by the UPF 506 and the SMF 504. For example, the UPF 506 (e.g., a first network entity of a core network) may detect QUIC traffic (e.g., receive a QUIC packet) and determine traffic classification information carried in a QUIC packet header of the QUIC traffic. The UPF 506 may report the detection to the SMF 504 (e.g., including QUIC traffic information). The SMF 504 (e.g., a second network entity of the core network) may generate (e.g., select, determine) a QoS policy to control the QUIC traffic transmission (e.g., PFCP rules). The UPF 506 may apply the PFCP rules to the QUIC traffic information.

At 510, the UE 502 may communicate a request to establish a PDU session. The SMF 504 may establish a PFCP association to the UPF 506 and download (e.g., send, transmit, communicate, indicate) PFCP rules to the UPF 506 in response to establishing a PDU session.

At 512, the UE 502 may set up a QUIC connection with a remote server (e.g., an application server of the UE 502, over a QoS flow selected by the UE 502) in response to a request by the application. To do so, the UE 502 may select a QoS flow that satisfies a QoS requirement of the application. Responsive to establishing the QUIC connection, the UE 502 and a remote server may allocate a pair of QUIC Connection IDs.

At 514, responsive to establishing the QUIC connection, the remote AS 508 and the UE 502 may exchange (e.g., communicate) uplink and/or downlink QUIC traffic based on application demand. In some cases, the remote AS 508 may set (e.g., configure) traffic classification information IE of a QUIC packet header with a value (e.g., when sending downlink QUIC traffic to the UE 502). Setting the traffic classification information IE when sending downlink QUIC traffic may expose information about inner service flows within the QUIC packet. In some examples, the UE 502 may set (e.g., configure) the traffic classification information IE of the QUIC packet header for uplink QUIC packets. The remote AS 508 and/or the UE 502 may communicate (e.g., send) the traffic (e.g., uplink and/or downlink traffic) with the traffic classification information in the QUIC packet header to an endpoint of the QUIC network.

At 516, the PFCP rules (e.g., downloaded from the SMF 504 at 510) may instruct the UPF 506 to detect (e.g., receive) QUIC traffic. Responsive to detecting the QUIC traffic, the UPF 506 may report the QUIC traffic information to the SMF 504.

At 518, the UPF 506 may send a PFCP Session Report request to the SMF 504, the PFCP Session Report request carrying the detected QUIC traffic information. The QUIC traffic information may include a combination of a source IP address, a destination IP address, a source UDP port, a destination UDP port, a QUIC Connection ID, and/or QUIC traffic classification information. The QUIC traffic classification information may include the content of the traffic classification information IE of the QUIC packet header, a TCV number, and a list of TCVs, or any combination thereof. At 520, the SMF 504 may send a PFCP Session Report response to the UPF 506.

At 522, responsive to receiving the PFCP session report, the SMF 504 may update (e.g., determine) the PFCP rules based on the received binding information (e.g., the QUIC traffic information). The SMF 504 can determine a QoS requirement of inner service flows within the QUIC packet (e.g., belonging to a corresponding QUIC connection) based on the QUIC traffic information reported by the UPF 506. The SMF 504 may generate PFCP rules for the QUIC traffic based on the determination and the QUIC traffic information. The SMF 504 may map TCVs included in the QUIC traffic classification information to a list of QFIs. The SMF 504 may determine which QoS applied to the QUIC connection satisfies a threshold (e.g., is an appropriate QoS applied to the QUIC connection). For example, the SMF 504 may select the QFI with a maximum QoS (e.g., relative to other QFIs) from the mapped QFI (e.g., a list of QFIs) as the QFI applied to the QUIC connection. At 524, the SMF 504 may send a PFCP Session Modification Request to the UPF 506. The PFCP Session Modification Request may include the generated (e.g., updated) PFCP rules.

At 526, the UPF 506 may send a PFCP Session Modification Response message to the SMF 504. For example, the UPF 506 may send the PFCP response message responsive to receiving the PFCP Session Modification Request. At 528, the UPF 506 may install (e.g., update, utilize) the updated PFCP rules received from the SMF 504.

The UPF 506 can thus detect the traffic classification information exposed in the QUIC packet header and detect information of the inner service flows within the QUIC traffic. The UPF 506 can report the detected QUIC traffic classification information to the SMF 504 and the SMF 504 can determine a QoS policy for the QUIC traffic.

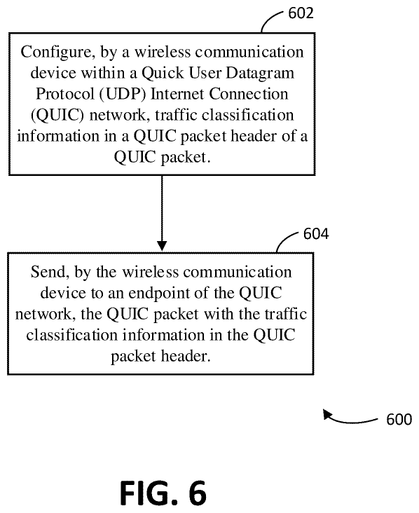

FIG. 6 is a flowchart diagram illustrating an example method 600 for traffic classification and handling, according to various arrangements. In some cases, the method 600 may include configurations for a wireless communication device to configure traffic classification information in a QUIC packet header.

At 602, a wireless communication device within a QUIC network may configure traffic classification information in a QUIC packet header of a QUIC packet. At 604, the wireless communication device may send, to an endpoint of the QUIC network, the QUIC packet with the traffic classification information in the QUIC packet header. In some cases, the traffic classification information may include a quantity of traffic classification values indicating information of one of inner service flows within the QUIC packet (e.g., a QoS level, a priority level, or a type of service), a list of traffic classification values, or both.

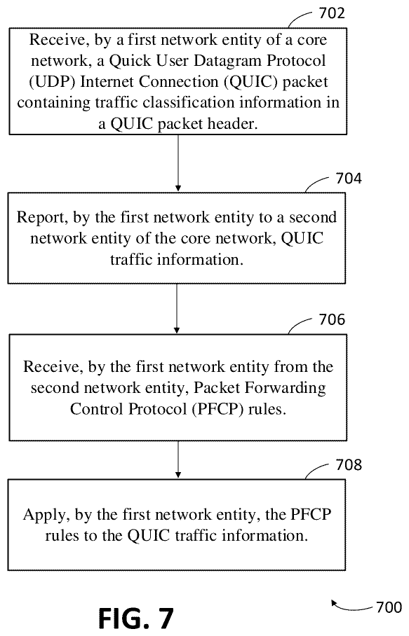

FIG. 7 is a flowchart diagram illustrating an example method 700 for traffic classification and handling, according to various arrangements. In some cases, the method 700 may include configurations a first network entity to receive QUIC packets containing traffic classification information in a QUIC packet header.

At 702, a first network entity of a core network may receive a QUIC packet containing (e.g., comprising) traffic classification information in a QUIC packet header. At 704, the first network entity may report, to a second network entity of the core network, QUIC traffic information. At 706, the first network entity may receive, from the second network entity, PFCP rules. At 708, the first network entity may apply the PFCP rules to the QUIC traffic information.

In some cases, the first network entity may send, to the second network entity, a PFCP session report. The QUIC traffic information may be included in the PFCP session report. The traffic classification information may include at least one of a number of traffic classification values or a list of classification values. Each of the traffic classification values may indicate information of one of inner service flows within the QUIC packet. Each of the traffic classification values includes one of a QoS level, a priority level, or a type of service.

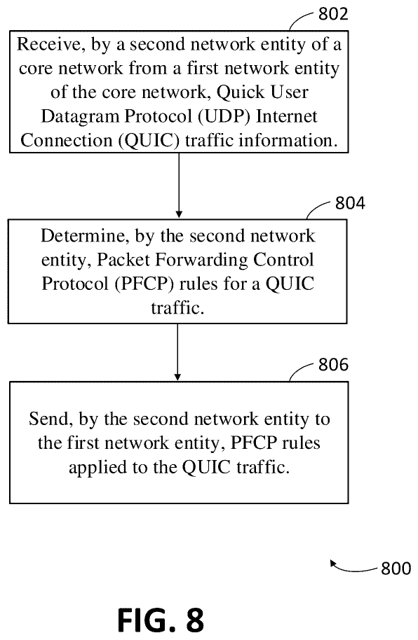

FIG. 8 is a flowchart diagram illustrating an example method 800 for traffic classification and handling, according to various arrangements. In some cases, the method 800 may include configurations for a second network entity to receive QUIC traffic information.

At 802, a second network entity of a core network may receive, from a first network entity of the core network, QUIC traffic information. At 804, the second network entity may determine PFCP rules for a QUIC traffic. At 806, the second network entity may send, to the first network entity, PFCP rules (e.g., of the determined PFCP rules) applied to the QUIC traffic. In some cases, the second network entity may receive, from the first network entity, a PFCP session report, the QUIC traffic information included in the PFCP session report. The QUIC traffic information includes at least one of a source IP address, a destination IP address, a source UDP port, a destination UDP port, a QUIC connection ID, or QUIC traffic classification information. The QUIC traffic information includes at least one of a number of traffic classification values or a list of classification values. Each of the traffic classification values may indicate information of one of inner service flows within a QUIC packet. Each of the traffic classification values may include one of a QoS level, a priority level, or a type of service.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
configuring, by a wireless communication device within a Quick User Datagram Protocol (UDP) Internet Connection (QUIC) network, traffic classification information in a QUIC packet header of a QUIC packet; and
sending, by the wireless communication device, to an endpoint of the QUIC network, the QUIC packet with the traffic classification information in the QUIC packet header.

2. The wireless communication method of claim 1, wherein the traffic classification information comprises at least one of: a number of traffic classification values or a list of traffic classification values.

3. The wireless communication method of claim 2, wherein each of the traffic classification values indicates information of one of inner service flows within the QUIC packet.

4. The wireless communication method of claim 2, wherein each of the traffic classification values comprises one of: a Quality of Service (QoS) level, a priority level, or a type of service.

5. A wireless communication method, comprising:
receiving, by a first network entity of a core network, a Quick User Datagram Protocol (UDP) Internet Connection (QUIC) packet with traffic classification information in a QUIC packet header of the QUIC packet;
reporting, by the first network entity, to a second network entity of the core network, QUIC traffic information;
receiving, by the first network entity, from the second network entity, Packet Forwarding Control Protocol (PFCP) rules; and
applying, by the first network entity, the PFCP rules to the QUIC traffic information.

6. The wireless communication method of claim 5, wherein the QUIC traffic information comprises at least one of: a source Internet Protocol (IP) address, a destination IP address, a source UDP port, a destination UDP port, a QUIC connection ID, or the traffic classification information.

7. The wireless communication method of claim 5, wherein the traffic classification information comprises at least one of: a number of traffic classification values or a list of traffic classification values.

8. The wireless communication method of claim 7, wherein each of the traffic classification values indicates information of one of inner service flows within the QUIC packet.

9. The wireless communication method of claim 7, wherein each of the traffic classification values comprises one of: a Quality of Service (QoS) level, a priority level, or a type of service.

10. The wireless communication method of claim 5, further comprising:
sending, by the first network entity, to the second network entity, a PFCP Session Report request, wherein the QUIC traffic information is included in the PFCP Session Report request.

11. A wireless communication method, comprising:
receiving, by a second network entity of a core network, from a first network entity of the core network, Quick User Datagram Protocol (UDP) Internet Connection (QUIC) traffic information;
determining, by the second network entity, Packet Forwarding Control Protocol (PFCP) rules for a QUIC traffic; and
sending, by the second network entity, to the first network entity, PFCP rules applied to the QUIC traffic.

12. The wireless communication method of claim 11, wherein the QUIC traffic information comprises at least one of: a source Internet Protocol (IP) address, a destination IP address, a source UDP port, a destination UDP port, a QUIC connection ID, or traffic classification information.

13. The wireless communication method of claim 12, wherein the traffic classification information comprises at least one of: a number of traffic classification values or a list of traffic classification values.

14. The wireless communication method of claim 13, wherein each of the traffic classification values indicates information of one of inner service flows within a QUIC packet.

15. The wireless communication method of claim 13, wherein each of the traffic classification values comprises one of: a Quality of Service (QoS) level, a priority level, or a type of service.

16. The wireless communication method of claim 11, further comprising:
receiving, by the second network entity from the first network entity, a PFCP Session Report request, wherein the QUIC traffic information is included in the PFCP Session Report request.

17. The wireless communication method of claim 6, wherein the traffic classification information comprises at least one of: a number of traffic classification values or a list of traffic classification values.

18. The wireless communication method of claim 17, wherein each of the traffic classification values indicates information of one of inner service flows within the QUIC packet.

19. The wireless communication method of claim 17, wherein each of the traffic classification values comprises one of: a QoS level, a priority level, or a type of service.
